(19) United States
(12) Patent Application Publication
(10) Pub. No.: US 2024/0030475 A1
(43) Pub. Date: Jan. 25, 2024

(54) Electrochemical Cell, More Particularly of a Redox Flow Battery, and Corresponding Cell Stack

(71) Applicant: Fraunhofer-Gesellschaft zur Förderung der angewandten Forschung e.V., München (DE)

(72) Inventor: Jan Girschik, Oberhausen (DE)

(21) Appl. No.: 18/027,779

(22) PCT Filed: Sep. 10, 2021
(86) PCT No.: PCT/EP2021/074972

§ 371 Date: Mar. 22, 2023

(30) Foreign Application Priority Data
Sep. 23, 2020 (DE) 10 2020 124 801.6

(51) Int. Cl. H01M 8/18; H01M 8/2483; H01M 8/0273; H01M 4/86

(52) U.S. Cl. CPC H01M 8/188; H01M 8/2483; H01M 8/0273; H01M 4/8631; H01M 2004/8694

(57) ABSTRACT

Described and illustrated is an electrochemical cell, in particular a redox flow battery, with at least one cell frame and at least one electrode. The cell frame circumferentially encloses a cell interior. The cell frame has at least one feed channel for feeding electrolyte into the cell interior and at least one discharge channel for discharging electrolyte from the cell interior. The at least one cell frame has at least one finger element projecting into the cell interior and wherein the electrode is arranged at least in regions in the cell interior and on opposite sides of the at least one finger element. In order to achieve a more appropriate flow through, which reliably allows for a lower pressure loss and a higher power density, it is provided that the at least one feed channel and/or the at least one discharge channel is provided at least in sections in the finger element and that the at least one finger element has at least one outlet opening into the cell interior for the electrolyte to be fed and/or at least one inlet opening from the cell interior for the electrolyte to be discharged.

### CROSS-REFERENCE TO RELATED APPLICATIONS

This application is the United States national phase of International Application No. PCT/EP2021/074972 filed Sep. 10, 2021, and claims priority to German Patent Application No. 10 2020 124 801.6 filed Sep. 23, 2020, the disclosures of which are hereby incorporated by reference in their entireties.

### BACKGROUND OF THE INVENTION

### Field of the Invention

The invention relates to an electrochemical cell, in particular a redox flow battery, having at least one cell frame and at least one electrode, wherein the cell frame circumferentially encloses a cell interior, wherein the cell frame has at least one feed channel for feeding electrolyte into the cell interior and at least one discharge channel for discharging electrolyte from the cell interior, wherein the at least one cell frame has at least one finger element projecting into the cell interior and wherein the electrode is arranged at least n regions in the cell interior and on opposite sides of the at least one finger element Furthermore, the invention relates to a cell stack, in particular of a redox flow battery, comprising a plurality of corresponding electrochemical cells.

### Description of Related Art

Electrochemical cells are known in various embodiments and are sometimes also referred to as electrochemical reactors, since electrochemical reactions take place in the electrochemical cells. Depending on their use, the electrochemical cells may, for example, be designed as galvanic cells in the form of electrochemical current sources that supply usable electrical energy through chemical reactions at the various electrodes. Alternatively, the electrochemical cells may also be electrolysis cells that serve to produce certain products by applying an external voltage. In this case, accumulator cells serve alternately as a current source, like galvanic cells, and also as a current storage device, as in the case of an electrolysis cell.

The present invention can be used in connection with all types of electrochemical cells. However, the invention is quite particularly preferred in connection with accumulator cells and here preferably in connection with redox flow batteries, which themselves have been known for a long time and in various embodiments. Such embodiments are described by way of example in EP 0 051 766 A1 and US 2004/0170893 A1. An important advantage of redox flow batteries is the flexible scalability of power and capacity and thus their suitability for storing very large amounts of energy even at low selected power levels and vice versa. The energy is stored in electrolytes, which can be kept ready in external tanks.

The electrolytes usually contain metallic ions of different oxidation states. To extract electrical energy from the electrolytes or to recharge them, the electrolytes are pumped through a so-called electrochemical cell.

The electrochemical cell is generally formed from two half-cells which are separated from each other by a separator in the form of a semipermeable membrane and each have an electrolyte and an electrode. The semipermeable membrane has the task of spatially and electrically separating the cathode and the anode of an electrochemical cell. The semipermeable membrane must therefore be permeable to ions, which cause the conversion of the stored chemical energy into electrical energy or vice versa. Semipermeable membranes can be formed, for example, from microporous plastics as well as nonwoven material made of glass fiber or polyethylene and so-called diaphragms. Redox reactions take place at both electrodes of the electrochemical cell, with electrons being released by the electrolytes at a electrode and electrons being absorbed at the other electrode. The metallic and/or non-metallic ions of the electrolytes form redox pairs and consequently generate a redox potential. Examples of redox pairs are iron-chromium, polysulfide-bromide or vanadium. These or other redox pairs can basically be present in aqueous or non-aqueous solution.

The electrodes of a cell, between which a potential difference is formed as a result of the redox potentials, are electrically connected to each other outside the cell, e.g. via an electrical load. While the electrons outside the cell pass from a half-cell to the other, ions of the electrolytes pass directly from a half-cell to the other half-cell through the semipermeable membrane. To recharge the redox flow battery, a potential difference can be applied to the electrodes of the half-cells instead of the electrical load, for example by means of a charger, which reverses the redox reactions taking place at the electrodes of the half-cells.

To form the cell described, cell frames are used, among other things, which enclose a cell interior. The cell frames typically do not completely enclose the cell interior, but only along a circumferential narrow side. Thus, the cell frame runs circumferentially around the cell interior and separates two opposite large-area sides from each other, which in turn are associated with a semipermeable membrane or an electrode. The thickness of the cell frame, which is formed by the edge of the cell frame, is typically significantly smaller than the width and height of the cell frame, which define the large-area opposite sides.

Each half-cell of the electrochemical cell comprises such a cell frame, which is manufactured, for example, by injection molding from a thermoplastic material. A semipermeable membrane is arranged between two cell frames, which separates electrolytes of the half-cells from each other with regard to a convective mass transfer, but allows diffusion of certain ions from a half-cell into the other half-cell. An electrode is also assigned to each of the cell interiors in such a way that the electrons are in contact with the electrolytes flowing through the cell interiors. The electrodes can, for example, close off the cell interior of each cell frame on the side facing away from the semipermeable membrane. In this case, the cell interior can remain essentially free and be filled only by a electrolyte in each case. However, the respective electrode may also be provided at least partially in the cell interior. In this case, the electrode is typically designed in such a way that the electrolyte can flow partially through the electrode. In many cases, electrodes with a high specific surface area come into question here, at which the corresponding electrochemical reactions can take place correspondingly quickly and/or extensively. This ultimately leads to a high volume-specific power of the cell. However, even if the electrode projects into the cell interior, the cell interiors are usually closed by the electrode on the side facing away from the semipermeable membrane. So-called bipolar plates, which can be coated with a catalyst or another substance, for example, can also be used as a non-porous part of the electrodes.

Each cell frame has openings and channels through which the corresponding electrolyte can flow from a supply line into the respective cell interior and be drawn off again from there and fed to a disposal line. The electrolytes of the half-cells are pumped via the supply line and the disposal line from a receiver tank into a collection tank. This allows the electrolytes to be reused, so they do not have to be discarded or replaced.

If the redox flow battery comprises only a single cell, supply lines for each half-cell and disposal lines for each half-cell are located outside the cell frames forming the half-cells. Each cell frame has at least two openings, at least one of which is connected to a supply line, while the at least one other opening is connected to the disposal line. Inside the cell frame, each opening is connected to a flow channel that is open to the cell interior. This allows electrolyte to be fed from the supply line to the cell interior via a feed channel and electrolyte, which flowed through the cell interior, to be discharged via a discharge channel. In order to distribute the electrolyte more uniformly over the width of the cell interior and to withdraw the electrolyte more uniformly over the width of the cell interior, the respective feed channel and/or discharge channel can be branched once or several times between the outer opening and the cell interior, i.e. in the region of the frame casing of the cell frame. Alternatively, a series of separate feed channels and/or discharge channels may be provided in the cell frame for feeding or discharging electrolyte. In both cases, the electrolyte enters the cell interior as uniformly distributed as possible via the outlet openings of the feed channels of one side of the cell frame and exits the cell interior again as uniformly distributed as possible via the discharge channels of the other side of the cell frame. In this way, an attempt is made to achieve the most uniform flow possible through the cell interior. The feed channels are connected to the supply line at their other end via inlet openings. This allows the electrolyte to pass from the supply line through the at least one feed channel of the cell frame of each half-cell into the corresponding cell interior.

If necessary, a plurality of electrochemical cells of the same type are combined in a redox flow battery. The cells are usually stacked on top of each other for this purpose, which is why the entirety of the cells is also referred to as a cell pack or cell stack. The individual cells usually have electrolytes flowing through them in parallel, while the cells are usually electrically connected in series. The cells are thus mostly connected hydraulically in parallel and electrically in series. In this case, the charge state of the electrolytes is the same in each case in one of the half-cells of the cell stack. To distribute the electrolytes to the corresponding half-cells of the cell stack and to discharge the electrolytes from the respective half-cells together, half-cells are connected to each other with supply and disposal lines. Since each half-cell or each cell interior of a cell has a different electrolyte flowing through it, the two electrolytes must be separated from each other as they pass through the cell stack. Therefore, two separate supply lines and two separate disposal lines are usually provided along the length of the cell stack. Each of these channels is usually formed in part by the cell frames themselves, which have four openings for this purpose. The openings extend along the length of the cell stack and form the supply and disposal lines, arranged one behind the other and separated from each other by sealing materials if necessary.

In a plurality of electrochemical cells, it has been shown that, in order to increase the power density, it is useful if the electrodes at least in one of the half-cells at least partially engage in the cell interior, are porous and have the corresponding electrolyte flowing through them. However, the increase in power density is often not satisfactory. This indicates that the surface area provided by the electrode is not fully utilized or not utilized as effectively as possible. This can be explained by non-uniform flow through the electrodes, as can be observed in the flow through similar porous solids. Even slight non-uniformities in porosity lead to non-uniform flow through, since the pressure losses depend strongly on the corresponding free flow cross-sections and the volume flow rate. However, non-uniform flow through of a cell interior can also occur if no porous section of the electrodes engages in the cell interior.

In order to guide the flow of electrolyte from the at least one feed channel to the at least one discharge channel through the cell interior, cell frames with finger elements or struts extending into or through the cell interior have been proposed. Cell chambers are then provided on either side of the finger element or strut. In the case of struts extending through the entire cell interior from one side to the opposite side, these can completely separate the cell chambers from one another through which different portions of the corresponding electrolyte flow. In the case of finger elements having a free end, the cell chambers are interconnected at least in the region of the free ends of the finger elements.

In all these cell chambers, if necessary, a part of an electrode can be provided with a porosity for the electrolyte to flow through. The porosity of the electrode allows the electrolyte to flow, at least in sections, through the electrode from a feed channel to a discharge channel of the same cell frame. Otherwise, the corresponding electrolyte flows along a non-porous surface of the corresponding electrode from a feed channel to a discharge channel of the same cell frame.

However, the use of corresponding finger elements or struts does not allow satisfactory flow through with a low, at best adjustable, pressure loss. Accordingly, the potential power density of corresponding electrochemical cells and cell stacks can only be achieved to a limited extent in many cases.

### SUMMARY OF THE INVENTION

Therefore, the present invention is based on the object of designing and further developing the electrochemical cells and the cell stack, each of the type mentioned at the beginning and explained in more detail above, in such a way that a more appropriate flow through can be achieved, which reliably allows for a lower pressure loss and a higher power density.

This object is solved in an electrochemical cell as described in that the at least one feed channel and/or the at least one discharge channel is provided at least in sections in the finger element, and in that the at least one finger element has at least one outlet opening into the cell interior for the electrolyte to be fed and/or at least one inlet opening from the cell interior for the electrolyte to be discharged.

Said task is further solved as described by a cell stack, in particular of a redox flow battery, comprising a plurality of electrochemical as described.

The finger elements of the cell frames can therefore be used not only to divide the cell interior into different cell chambers and to guide the flow of electrolytes in the cell interior accordingly. In some cases, the finger elements also accommodate at least one feed channel and/or one discharge channel, so that the electrolyte can enter the cell interior and/or exit the cell interior via corresponding outlet openings and/or inlet openings. In this way, the flow of the electrolyte can be specified and adjusted much more precisely. Consequently, the flow of the electrolyte is less random and dependent on the unavoidable irregularities of the cell interior, in particular of an electrolyte provided in the cell interior. Consequently, the pressure loss can be predicted more reliably. In addition, the flow of the electrolyte can also be distributed more uniformly, with the electrolyte having to travel shorter distances if necessary. Consequently, the pressure loss of the electrolyte across the cell interior can be reduced by the appropriate use of the finger elements of the cell frame.

In particular, the cell frame has a plate-like shape in which the cell interior is integrated. The cell frame thus has a height or thickness perpendicular to a plane defined by the cell interior or by the cell frame itself, which height or thickness can be many times smaller than the length or width parallel to the plane defined by the cell interior or by the cell frame itself. In addition, it is simpler and more convenient if the cell frame has at least a substantially constant height or thickness circumferentially around the cell interior. In this case, the height or thickness of the cell interior may, if necessary, at least substantially correspond to the height or thickness of the cell frame. In particular, however, the height of the cell interior can also be somewhat less than the height of the cell frame because the semipermeable membrane and/or a non-permeable section of the electrode can be provided at least partially n the cell frame. Furthermore, it is convenient if the cell frame is made of a plastic, in which case manufacturing by way of injection molding is suitable, for forming the at least one feed channel and/or the at least one discharge channel in the cell frame in a simple manner.

In a first particularly preferred embodiment of the electrochemical cell, the electrode in the cell interior has porosity for flow through of the electrolyte at least partially from the at least one feed channel to the at least one discharge channel. Since the porous section of the electrode can be traversed by the electrolyte, unlike a non-porous section of the electrode provided in a preferred manner, the space occupied by the porous section of the electrode is associated with the cell interior, which is plausible, particularly from a functional point of view. The porous section of the electrode can be formed in one-piece or in several pieces, whereby a one-piece design may be suitable for the sake of simplicity. Furthermore, the electrode can be formed from fibers, in particular felt-like. In principle, graphite, which can be in the form of graphite fibers, is a suitable material for the electrode, at least the porous part of the electrode. The porosity of the electrode provides a significantly larger boundary surface between the electrode and the electrolyte, which favors the processes and reactions taking place in the corresponding boundary surface. In particular, the processes and reactions take place more quickly and/or more comprehensively.

In this context, it is particularly useful if the electrode has different sections. A porous section of the electrode is provided in the cell interior and is electrically conductively connected to a non-porous section of the electrode. Unlike the porous section of the electrode, no electrolyte can pass through the non-porous section of the electrode. This can be used to at least partially close the cell interior. The cell interior can be closed off in particular on a side of the cell frame, which is opposite a semipermeable membrane and can in turn close off the cell interior on the corresponding side. The cell interior is closed by the electrode and the semipermeable membrane on the sides defining the length and width of the cell frame and by the cell frame itself on the narrow sides of the cell frame defining the height or thickness of the cell frame. However, this does not preclude electrolyte from being fed to the cell interior via the at least one feed channel and/or electrolyte from being withdrawn via the at least one discharge channel. In this way, a cell stack of multiple electrochemical cells stacked on top of each other can also be formed very easily and efficiently. Regardless of this, the non-porous section of the electrode can be in the form of a bipolar plate. The use of bipolar plates in combination with porous electrodes has already been provided for a number of known electrochemical cells. A similar design appears advantageous here for simplicity.

During production of the electrochemical cell or a cell stack the electrode can be inadvertently compressed at least in its porous regions. However, the flow through of the electrode in these regions can then no longer be as desired, resulting in increased pressure losses. However, correspondingly increased pressures of the electrolyte are regularly undesirable, because this can easily lead to damage and/or leakage of the electrochemical cell or cell stack. To prevent the electrode from being excessively compressed and/or to allow the electrolyte to flow as uniformly as possible through the cell interior, it is expedient, if necessary, for the at least one finger element to be designed as an at least substantially continuous strut bridging the cell interior. In this way, two cell chambers of the cell interior can be separated from each other by the finger element, so that the conditions in one cell chamber do not influence the conditions in the other cell chamber, or only to a limited extent. Thus, the flow of electrolyte in at least one of the cell chambers is more predictable and at least approximately as predetermined, which may improve the overall performance of the electrochemical cell.

A finger element is basically understood to be one that can have a free end. The finger element can therefore project into the cell interior and end with its free end in the cell interior. However, the finger element can also be designed without a free end, in that the finger element is designed in the form of a strut which is connected at two different points to the region of the cell frame enclosing the cell interior and extends between them through the cell interior, the finger element or the strut preferably delimiting two cell chambers from one another. In this regard, it is further preferred if the strut extends transversely through the cell interior from one side of the cell frame to the opposite side of the cell frame. Moreover, for simplicity, this may be in a direction parallel to the length or width of the cell frame and/or the cell interior. Alternatively or additionally, it is also preferred for simplicity if the finger elements or struts extend in a straight line through the cell interior.

Accidental excessive compression of certain subregions of the electrode can be avoided simply by ensuring that the height of the at least one finger element corresponds at least in sections at least substantially to the height of the cell interior and/or the cell frame in the corresponding region of the finger element. Then excessive pressure forces can be dissipated on the cell frame without having to be absorbed by the electrode to any appreciable extent as required. This is particularly the case when the finger element bears on one side against a semipermeable membrane and on the opposite side against a non-porous section of the electrode. Then the forces dissipated on the cell frame can then be dissipated to the adjoining components, so that the pressures that occur cannot lead to undesirable deformation of the electrochemical cell, or only to a minor extent.

The pressure loss of the electrolyte across the cell interior can be reduced by ensuring that the flow of the electrolyte through the cell interior is more uniform. To achieve this, at least one flow channel can be inset into the electrode. The flow channel is characterized by the fact that the free flow cross-section in the flow channel is significantly larger, in particular many times larger, than the mean pore diameter of the porous section of the electrode. Electrolyte can then enter the pores of the electrode via the flow channel. Alternatively or additionally, electrolyte exiting from the pores of the electrode can be collected in the flow channel. Against this background, it is also particularly suitable if the at least one flow channel is inset into the porous section of the electrode. Alternatively or additionally, it may accordingly also be expedient if the at least one flow channel adjoins an inlet opening and/or outlet opening of the at least one finger element. Then, the electrolyte to be distributed can be distributed in the porosity of the electrode via the flow channel and/or the electrolyte to be collected can be collected via the flow channel.

Furthermore, a uniform and predictable flow can be ensured if at least one flow channel of the electrode adjoining an inlet opening and at least one flow channel of the electrode adjoining an outlet opening are spaced apart from each other via a porous section of the electrode for the flow through of electrolyte. Then a so-called short-circuit flow cannot occur, but the electrolyte must always flow a minimum distance through the pores of the porous section of the electrode. In the case of several such flow channels, it is therefore also advisable for each of these to be spaced apart from one another via a porous section of the electrode for the flow through of electrolyte.

The distribution of the flow of the electrolyte to the cell interior of the cell frame can be uniform if the flow channels adjoining at least one inlet opening and the flow channels adjoining at least one outlet opening are in at least one direction each provided alternately with respect to one another. In this case, this direction is preferably aligned parallel to a plane defined by the cell frame. Alternatively or additionally, a uniform flow of the electrolyte in the cell interior can be supported by the at least one flow channel of the electrode and the at least one finger element of the cell frame being arranged at least substantially perpendicular to one another. Then the electrolyte can flow in one direction through the finger element in a direction perpendicular thereto through the at least one flow channel of the electrode.

The advantages associated with the at least one finger element can be utilized even more extensively, if required, if a plurality of finger elements arranged at least substantially parallel to one another is provided. In this way, a uniform flow through of electrolyte through the cell interiors can be achieved even with larger cell interiors. The same applies alternatively or additionally in the case where a plurality of at least substantially parallel flow channels is provided in the electrode.

In order to use the cell interior as efficiently as possible for the electrolyte to flow through, it is advisable that an odd number of finger elements is provided with the corresponding cell frame. This applies in particular to the case where the finger elements alternately comprise in the order of their arrangement at least partially a feed channel and a discharge channel. Then the electrolyte can be fed to the cell interior via a feed channel in a finger element and discharged via a discharge channel of an adjacent finger element or of the circumferential edge of the cell frame. In addition, the flow direction of the electrolyte in the cell interior can be precisely specified in this way, namely always from a feed channel to a discharge channel.

Like the struts, the finger elements do not necessarily have to be rectilinear. It can be useful, for example, if the finger elements or the struts form a grid structure. In this way, the cell interior can be divided into individual quadrants, which can then form individual separate cell chambers. Furthermore, the additional connections can lead to additional stiffening of the cell frame. It is also possible that individual segments of the finger elements or the struts can then be used for a materially bonded or form-fitting connection with adjacent semipermeable membranes or, in particular, non-porous sections of, electrodes. In this context, but not only in this context, it may prove useful if in a finger element or in a strut the at least one feed channel and/or the at least one discharge channel extends in one direction only. In sections of the finger element or the strut aligned transversely to the at least one feed channel and/or the at least one discharge channel, no electrolyte is then conducted; these sections then serve other purposes than conducting the electrolyte.

Regardless of the design of the finger elements or the struts, however, it may be advisable for the at least one finger element to be materially bonded to the semipermeable membrane and/or to, in particular the non-porous section of, the electrode. In this way, the electrochemical cell becomes more stable and rigid overall. The cell frame and thus the electrochemical cell as a whole are therefore less susceptible to undesirable deformation or leakage. In the case of the electrode, this is particularly true if the at least one finger element is connected to the bipolar plate, which typically already provides a high torsional stiffness or area moment of inertia itself. In the case of a structurally simple materially bonded connection, adhesive bonded or welded connections are particularly suitable.

The non-porous section of the electrode, which can be designed in particular as a bipolar plate, and the porous section of the electrode do not have to be firmly connected to each other. This makes it possible to simplify the manufacture of the electrochemical cell and to avoid damage to the electrode. Nevertheless, it will be regularly preferred if the non-porous section of the electrode or the bipolar plate and the porous section of the electrode engage in a form-fitting manner. This allows a slight movement of said electrode sections and at the same time ensures that these sections of the electrode remain reliably aligned with each other in a predetermined manner, e.g. during assembly and operation.

For a simple yet effective positive connection of the porous section of the electrode to the non-porous section of the electrode, it is useful if the non-porous section of the electrode has ribs. The ribs of the non-porous section of the electrode or bipolar plate can then engage in a form-fitting manner in the porous section of the electrode to position the different sections of the electrode against each other. If the ribs of the non-porous section of the electrode or of the bipolar plate engage at least in sections in a form-fitting manner in the flow channels of the porous section of the electrode, not only is the structure of the electrode stiffened overall, but a uniform flow of the electrolyte through the cell interior is also promoted, since the width of the flow channels remains constant due to the form fit.

In a first particularly preferred embodiment of the cell stack, the finger elements are provided in each case in both half-cells of the plurality of electrochemical cells. In this way, the advantages described above can be used all the more or in both half-cells of the electrochemical cells. In this context, it is particularly advantageous if the finger elements in at least mutually adjacent half-cells are arranged in each case at least in sections at least substantially aligned with one another in the stacking direction of the electrochemical cells. In this way, the flow of electrolyte in the cell interiors of the half-cells can be uniform. In addition, a form fit between the cell frames, the semipermeable membranes and, if necessary, the electrodes can be achieved in this way, which allows forces to be dissipated via the finger elements to adjacent finger elements via different half-cells and, if necessary, via different electrochemical cells. In this way, a stable and rigid cell stack can be provided that is less prone to deforming in undesirable ways or leaking, for example, without the need for excessive contact pressures between the half-cells and/or the electrochemical cells.

The corresponding form closure can be achieved in particular without excessive compression of the electrodes, which are flowed through non-uniformly as a result of such compression, if the height of the respectively aligned sections of the finger elements corresponds at least substantially to the height of the respective cell interior and/or of the respective cell frame in each case in the region of the aligned sections of the finger elements. The finger elements are then preferably in contact with the semipermeable membranes and the electrodes, so that the finger elements can transmit forces to adjacent finger elements without requiring any appreciable deformation of the electrochemical cells or the cell stack. This is particularly true if the respectively aligned sections of the finger elements bear on one side against a semipermeable membrane and on the opposite side against a non-porous section of the electrode, in particular the bipolar plate.

### BRIEF DESCRIPTION OF THE DRAWINGS

The invention is explained in more detail below by means of a drawing which merely illustrates an example of an embodiment. The drawing shows in

FIG. 1A-B a first cell stack according to the invention in the form of a redox flow battery in a longitudinal sectional view,

FIG. 2A-D a cell frame of an electrochemical cell according to the invention of the cell stack of FIG. 1 together with an associated electrode in the cell interior of the cell frame in a plan view and in opposite sectional views along a sectional plane B-B or C-C perpendicular to the plane of the cell frame,

FIG. 3 a part of the electrode from FIG. 2 in a perspective view and

FIG. 4 a detail of a second cell stack according to the invention in a magnified view.

### DESCRIPTION OF THE INVENTION

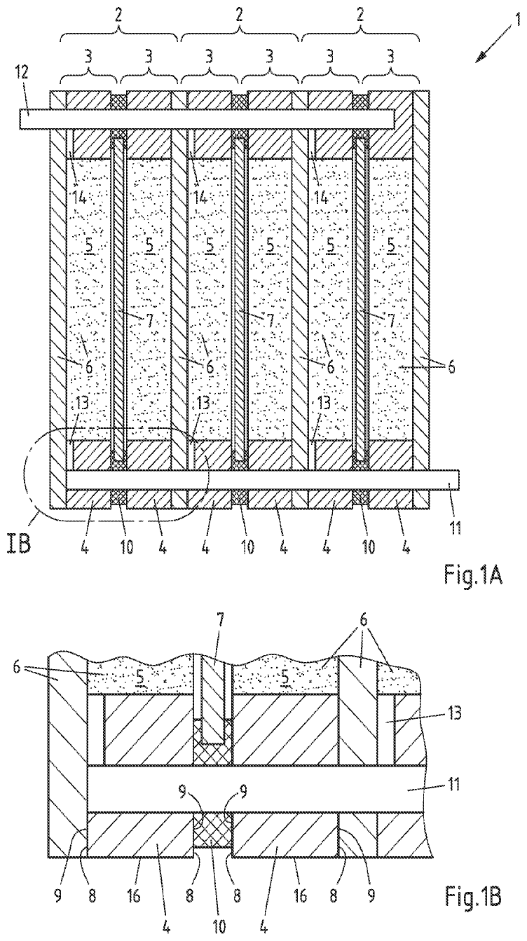

In FIGS. 1A and 1B, a cell stack 1, i.e. a cell pack of an electrochemical cell 2, in particular in the form of a redox flow battery, is shown in a longitudinal sectional view. The cell stack 1 comprises three cells 2, each having two half-cells 3 with corresponding electrolytes. Each half-cell 3 has a cell frame 4 which comprises a cell interior 5 through which an electrolyte stored in a receiver tank can be passed and in which an electrode 6 engages at least partially, which moreover completes and closes off the cell interior 5 to one side. The electrolytes flowing through the cell interiors 5 differ from one another. The respective cell interior 5 is closed on the side facing away from the electrode 6 adjacent to the cell frame 4 of the second half-cell 3 of the same electrochemical cell 2 by a semipermeable membrane 7 provided between the cell frames 4 of the two half-cells 3. Convective transfer of the two different electrolytes of the two half-cells 3 into the cell interior 5 of the cell frame 4 of the other half-cell 3 is thus prevented. However, ions can pass from one electrolyte to the other electrolyte by diffusion via the semipermeable membrane 7, resulting in charge transport

Redox reactions of the redox pairs of the electrolytes at the electrodes 6 of the half-cells 3 of a cell 2 either release or absorb electrons. The released electrons can flow from one electrode 6 to the other electrode 6 of a cell 2 via an electrical connection provided outside the redox flow battery and having an electrical load if required. Which reactions take place at which electrode 6 depends on whether the redox flow battery is being charged or discharged.

In the cell stack 1 shown, the electrodes 6 lie flat on an outer side 8 of the cell frame 4. The electrode 6 thus forms a frame surface in the contact area with the outer side 8 of the cell frame 4, which acts as a sealing surface 9. Between the facing outer sides 8 of the cell frames 4 of a cell 2 is a sealing material 10 in which the membrane 7 is sealingly received. The sealing material 10 lies flat against the outer sides 8 of the adjacent cell frames 4 and thus forms frame surfaces which act as sealing surfaces 9.

Four channels extend longitudinally to the cell stack 1 in the redox flow battery shown. Two of these are supply lines 11 for feeding the two electrolytes to the cell interiors 5 of the cell frames 4. The two other channels are disposal lines 12 for discharging the electrolytes from the cell interiors 5 of the cell frames 4. FIG. 1A shows a supply line 11 and a disposal line 12 in each case. A feed channel 13 branches off from the supply line 11 in respectively one half-cell 3 of each cell 2, via which the electrolyte can be fed to the corresponding cell interior 5 of the half-cell 3. A discharge channel 14 is provided at opposite sections of the corresponding cell frames 4, via which the electrolyte can be discharged from the cell interiors 5 into the disposal line 12. The supply line 11 not shown in FIG. 1A and disposal line 12 also not shown enable the second electrolyte to flow through the respective other cell interiors 5 of the other half-cells 3 via a similar feed channel 13 and discharge channel 14.

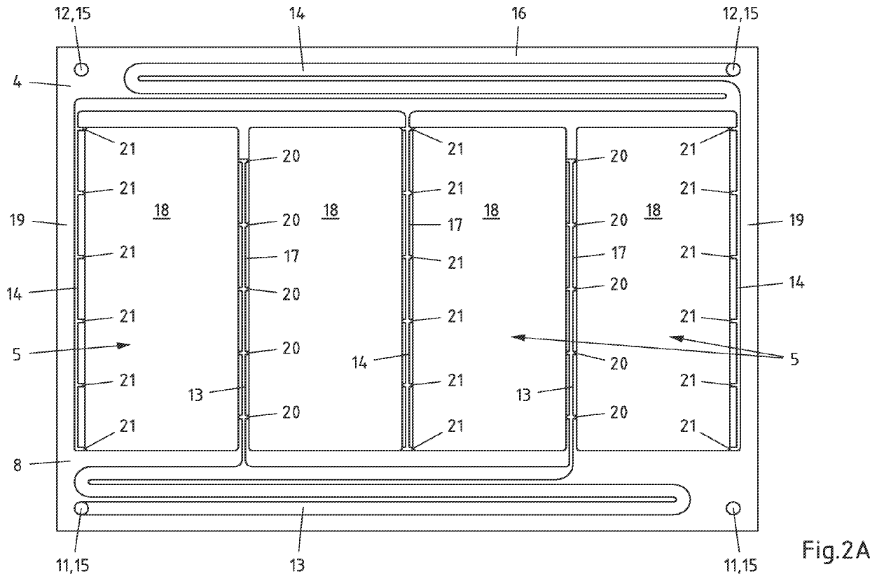

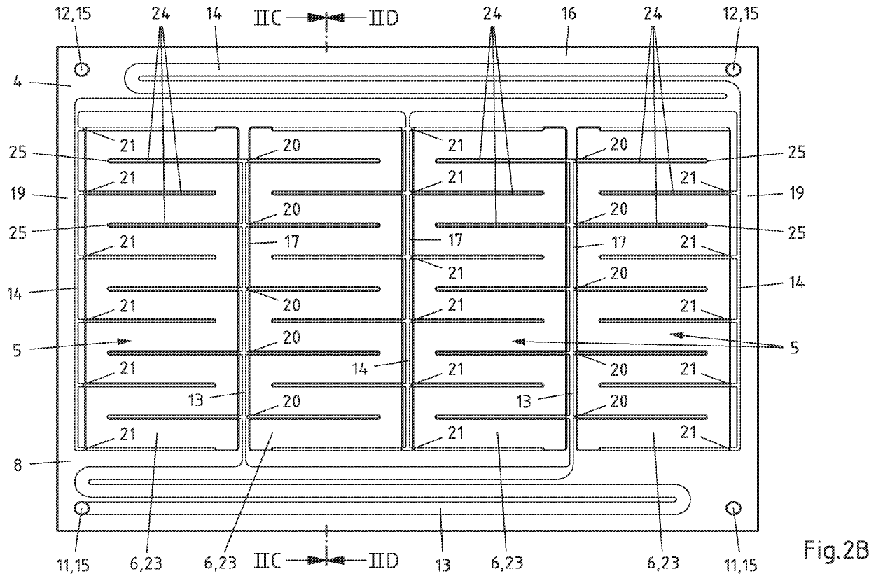

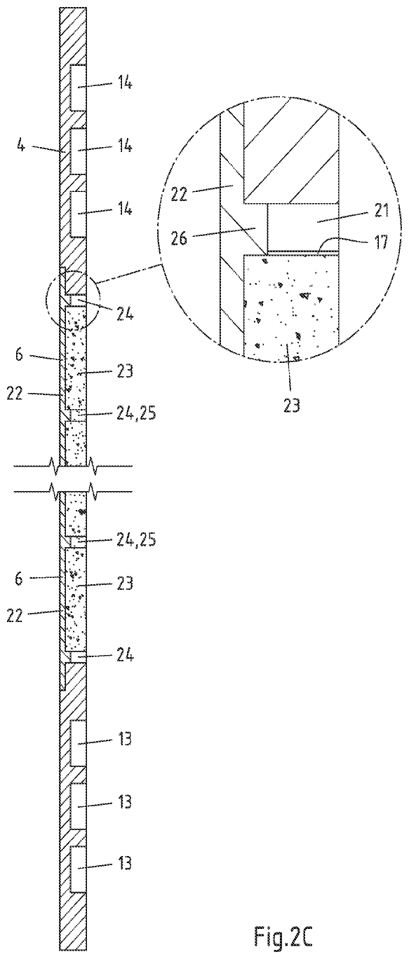

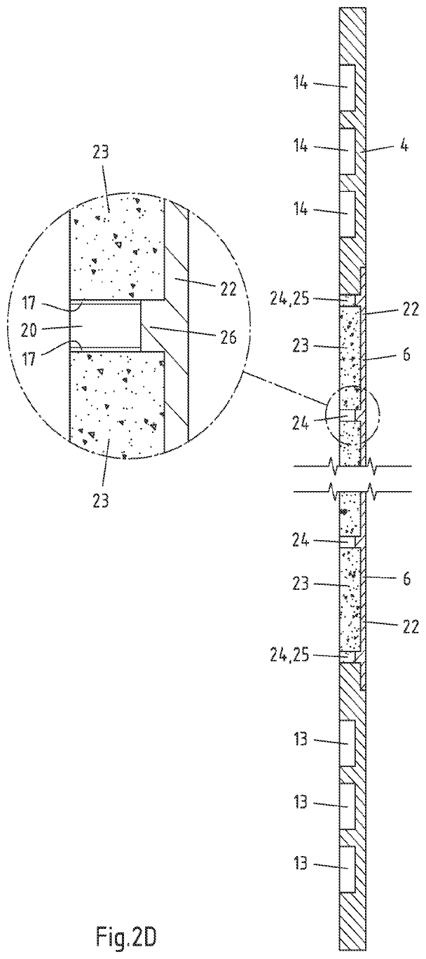

FIGS. 2A-B show plan views of a cell frame 4 and sectional views along a common sectional plane but in opposite viewing directions. For the sake of clarity, FIG. 2A shows the cell frame without electrode and FIG. 2B shows the same cell frame with inserted electrode. In the sectional views according to FIG. 2C-D, the electrodes are also shown inserted. Four openings 15 are provided in the corners of the cell frame 3, each opening 15 forming part of a supply line 11 or a disposal line 12. The feed channel 13 and the discharge channel 14 are recessed as recesses or open channels in the shown outer side 8 of the frame casing 16 of the cell frame 4, which surrounds the cell interior 5. The feed channel 13 and the discharge channel 14 are closed to form circumferentially closed lines when assembled into a cell stack 1. In the cell stack 1 shown, this is done, for example and in sections, by the sealing materials 10 and the electrodes 6. However, the electrodes 6 could also be spatially separated from the supply lines 11 and the disposal lines 12 by sealing materials 10 and/or the electrical insulation of these materials. Alternatively or additionally, the sealing material 10 adjacent to the semipermeable membrane 7, the feed channels 13 and the discharge channels 14 could also be omitted.

The feed channel 13 and the discharge channel 14 are branched in the embodiment shown, so that the electrolyte can be fed distributed via the cell interior 5 via the feed channel 13 and discharged distributed via the discharge channel 14. However, this is not necessary. Thus, feed channels 13 branching off separately from the supply line 11 could also be provided. Likewise, discharge channels 14 connected separately to a disposal line 12 could also be provided.

The cell frame 4 shown, which is preferred in this respect, is provided circumferentially to the cell interior 5 and also has three finger elements 17 formed as struts, which extend transversely through the cell interior 5 and thus divide the cell interior 5 into four cell chambers 18, which are completely separated from one another in the cell frame 4 shown. Moreover, the finger elements 17 extend parallel to the plane of the cell frame 4 and parallel to each other as well as parallel to the longitudinal extension of the cell frame 4. Furthermore, the finger elements 17 are spaced at least substantially equidistant from the adjacent finger element 17 or the lateral edge 19 of the cell interior 5. In this way, cell chambers 18 of equal size are provided. In the cell frame 4 shown and preferred in this respect, two finger elements 17 each have a part of the feed channel 13 which is also formed as an open channel in the region of the finger elements 17 and is closed by the semipermeable membrane 7 or the electrode 6. The third and middle finger element 17, on the other hand, has a part of the discharge channel 14, which is also formed as an open channel, which is closed by the semipermeable membrane 7 or the electrode 6 when the cell 2 is assembled. In the cell frame 4 shown, parts of the discharge channel 14 are also still provided in the lateral edges 19, into which electrolyte can flow from the cell interior 5. However, parts of the feed channel 13 could also be provided in the sides of the cell frame 4. Then, however, finger elements 17 would preferably each follow inwardly with a part of the discharge channel 14. In this way, for example, the electrolyte is passed from the feed channel 13 to the discharge channel 14 via a cell chamber 18 in each case.

The electrolyte flows into the cell interior 5 via outlet openings 20, which are distributed along the longitudinal extent of the finger element 17. The electrolyte flows out of the cell interior 5 or the cell chambers 18 via inlet openings 21 into the discharge channel 14. In the cell frame 4 shown and preferred in this respect, the inlet openings 21 are provided in the finger element 17 and in the lateral edges 19 of the cell frame 4. If a feed channel 13 is provided in the lateral edges 19 of the cell frame 4, outlet openings 20 are preferably also provided there in order to allow the electrolyte to flow from there into the cell interior 5.

The outlet openings 20 and the inlet openings 21 are shown in FIGS. 2C-D. It is also shown that the finger elements 17 extend over at least substantially the entire height of the cell frame 4. However, a part of the height of the cell frame 4 in the region of the finger elements 17 is provided by the electrode 6. This section of the electrode 6 constitutes the non-porous section 22 of the electrode 6 in the form of a bipolar plate. The porous section 23 of the electrode 6 extends into the cell chambers 18 of the cell interior 5 and is provided in electrically conductive contact with the non-porous section 22 of the electrode 6. The porous section 23 of the electrode 6 has flow channels 24, one end of each of which connects to an outlet opening 20 of the feed channel 13 or an inlet opening 21 of the discharge channel 14. The flow channels 24 run parallel to one another and at an at least substantially equal distance from one another. Along the flow channels 24, ribs 26 are provided in the non-porous section 22 of the electrode 6, which ribs engage in a form-fitting manner in the flow channels 24 of the porous section 23 of the electrode 6.

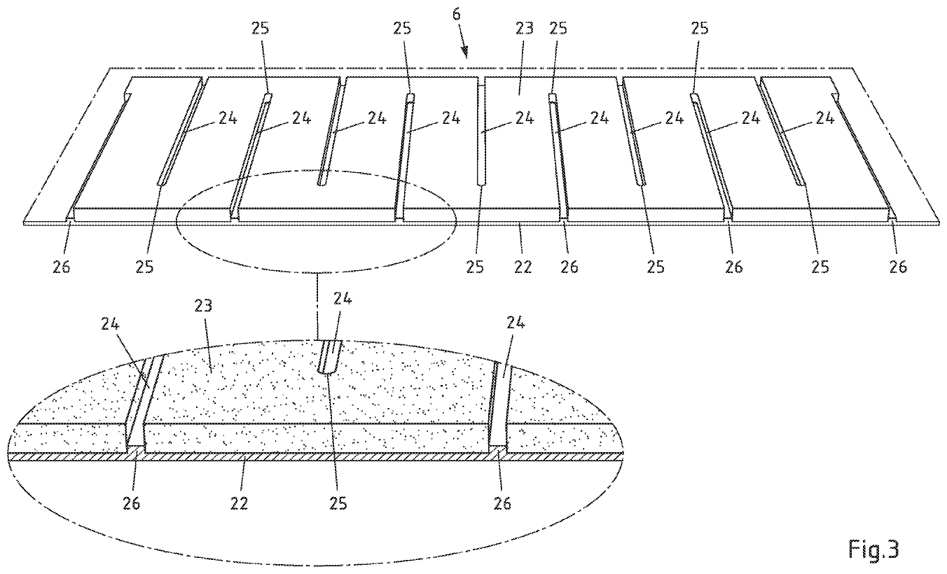

This form fit is also shown in FIG. 3. However, as an alternative to the form fit shown, another form fit could also be provided between the porous section 23 and the non-porous section 22 of the electrode 6. In this case, the flow channels 24 are provided with a free end 25 so that the flow channels 24 are not in direct contact with each other. The flow channels 24 are each spaced apart from each other via porous sections of the electrode 6. In addition, the flow channels 24 extend over the predominant width of the cell chamber 18. The length of the flow channels 24 being approximately equal in this case. In this regard, it makes no difference whether the flow channels 24 connect to a feed channel 13 or a discharge channel 14. In the case of the electrode 6 shown, the flow channels 24 are cut out of the porous material of the electrode 6. The porous material of the electrode 6 is a kind of felt made of graphite fibers. In contrast, the non-porous section 22 of the electrode 6 is in the form of a solid plate of graphite, from which the ribs 26 for the form fit with the porous section 23 of the electrode 6 project. In this case, the thickness of the porous section 23 of the electrode 6 is significantly greater than the height of the ribs 26. In many cases, it is convenient if the thickness of the porous section 23 of the electrode 6 is at least twice as great as the height of the ribs 26 of the non-porous section 22 of the electrode 6. In the present case, the thickness of the porous section 23 of the electrode 6 is at least three times as great as the height of the ribs 26.

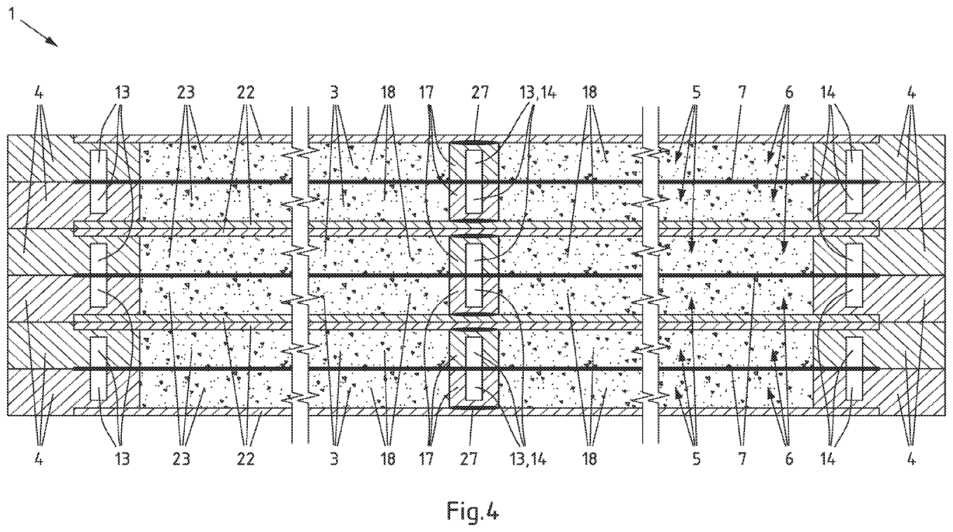

FIG. 4 shows a detail of a section through a cell stack 1 extending over several half-cells 3. Here, each of the half-cells 3 comprises a cell frame 4, with a semipermeable membrane 7 or a non-porous section 22 of the electrode 6 provided between each two cell frames 4. Here, the semipermeable membrane 7 and the non-porous section 22 of the electrode 6 are connected to the associated cell frames 4 without a sealant. In this case, the connection has been joined materially bonding and by way of welding the cell frames 4 formed from a thermoplastic and the semipermeable membranes 7 or electrodes 6, which are also at least partially made from a thermoplastic. However, the cell stack 1 could in principle also be designed in a different way.

Between a semipermeable membrane 7 and a non-porous section 22 of the electrode 6, a finger element 17 is provided in each case, in which a feed channel 13 or discharge channel 14 is provided in the form of an open channel closed in each case by the semipermeable membrane 7. In the case of the cell stack 1 shown, the finger elements 17 are connected, in particular welded, to the non-porous sections 22 of the electrodes 6 via materially bonded connections 27. Furthermore, the finger elements 17 extend from the porous section 23 of the electrode 6 to the adjacent semipermeable membrane 7, thus over the entire height of the cell interior 5, so that two adjacent cell chambers 18 are separated from each other. Furthermore, the corresponding finger elements 17 of the successive half-cells 3 are each arranged aligned with one another in the stacking direction of the half-cells 3. In this way, a form-fitting, indirect force transmission from one finger element 17 to the next finger element 17 can take place, whereby the forces between two finger elements 17 in each case can be transmitted via a semipermeable membrane 7 or a non-porous section 22 of an electrode 6. Consequently, the corresponding forces do not lead to a compression of the porous sections 23 of the electrodes 6 in the cell interior 5 or the cell chambers 18.

### LIST OF REFERENCE SIGNS

1 Cell stack
2 Cell
3 Half-cell
4 Cell frame
5 Cell interior
6 Electrode
7 Semipermeable membrane
8 Outer side
9 Sealing surface
10 Sealing material
11 Supply line
12 Disposal line
13 Feed channel
14 Discharge channel
15 Openings
16 Frame casing
17 Finger element
18 Cell chamber
19 Lateral edge
20 Outlet opening
21 Inlet opening
22 Non-porous section
23 Porous section
24 Flow channel
25 Free end
26 Rib
27 Connection

1. A electrochemical cell, in particular of a redox flow battery, having at least one cell frame and at least one electrode, wherein the cell frame circumferentially encloses a cell interior, wherein the cell frame has at least one feed channel for feeding electrolyte into the cell interior and at least one discharge channel for discharging electrolyte from the cell interior, wherein the at least one cell frame has at least one finger element projecting into the cell interior and wherein the electrode is arranged at least in regions in the cell interior and on opposite sides of the at least one finger element,
wherein
the at least one feed channel and/or the at least one discharge channel is provided at least in sections in the finger element, and in that the at least one finger element has at least one outlet opening into the cell interior for the electrolyte to be fed and/or at least one inlet opening from the cell interior for the electrolyte to be discharged.

2. The electrochemical cell according to claim 1,
wherein
the electrode in the cell interior has a porosity for the flow through of the electrolyte at least partially from the at least one feed channel to the at least one discharge channel.

3. The electrochemical cell according to claim 2,
wherein
a non-porous section of the electrode, in particular in the form of a bipolar plate, which is electrically conductively connected to a porous section of the electrode, closes the cell interior on a side opposite of a semipermeable membrane.

4. The electrochemical cell according to claim 1,
wherein
the at least one finger element is formed as a continuous strut bridging the cell interior and separating two cell chambers of the cell interior from each other.

5. The electrochemical cell according to claim 1,
wherein
the height of the at least one finger element corresponds at least in sections at least substantially to the height of the cell interior and/or of the cell frame in the corresponding region of the finger element, and in that, preferably, the finger element bears on one side against a semipermeable membrane and on the opposite side against a non-porous section of the electrode.

6. The electrochemical cell according to claim 1,
wherein
at least one flow channel is inset into, in particular the porous section, of the electrode, and in that, preferably, the at least one flow channel adjoins an inlet opening and/or outlet opening of the at least one finger element.

7. The electrochemical cell according to claim 6,
wherein
at least one flow channel of the electrode adjoining an inlet opening and at least one flow channel of the electrode adjoining an outlet opening, in particular in each case, are spaced apart from one another via a porous section of the electrode for the flow through of electrolyte.

8. The electrochemical cell according to claim 6,
wherein
flow channels adjoining at least one inlet opening and flow channels adjoining at least one outlet opening are in at least one direction each provided alternately with respect to one another and/or in that the at least one flow channel of the electrode and the at least one finger element of the cell frame are arranged at least substantially perpendicular to one another.

9. The electrochemical cell according to claim 1,
wherein
a plurality of finger elements arranged at least substantially parallel to one another is provided and/or that a plurality of at least substantially parallel flow channels is provided in the electrode.

10. The electrochemical cell according to claim 1,
wherein
an odd number of finger elements is provided and in that, preferably, the finger elements alternately comprise in the order of their arrangement at least partially a feed channel and a discharge channel.

11. The electrochemical cell according to claim 1,
wherein
the at least one finger element forms a grid structure.

12. The electrochemical cell according to claim 3,
wherein
the at least one finger element is materially bonded to the semipermeable membrane and/or to the non-porous section of the electrode, in particular the bipolar plate, and in that, preferably, the materially bonded connection is joined by means of adhesive bonding or welding.

13. The electrochemical cell according to claim 3,
wherein
the non-porous section of the electrode, in particular the bipolar plate, and the porous section of the electrode are not firmly connected to one another, and in that, preferably, the non-porous section of the electrode, in particular the bipolar plate, and the porous section of the electrode engage in one another in a form-fitting manner.

14. The electrochemical cell according to claim 13,
wherein
ribs of the non-porous section of the electrode, in particular of the bipolar plate, engage in a form-fitting manner in the porous section of the electrode, and in that, preferably, the ribs of the non-porous section of the electrode, in particular of the bipolar plate, engage at least in sections in a form-fitting manner in the flow channels of the porous section of the electrode.

15. A cell stack, in particular of a redox flow battery, comprising a plurality of electrochemical cells according to claim 1.

16. The cell stack according to claim 15,
wherein
the finger elements are provided in each case in both half-cells of the plurality of electrochemical cells and/or in that the finger elements of at least mutually adjacent half-cells are arranged in each case at least in sections at least substantially aligned with one another in the stacking direction of the electrochemical cells.

17. The cell stack according to claim 15,
wherein
the height of the respectively aligned sections of the finger elements corresponds at least substantially to the height of the respective cell interior and/or of the respective cell frame in each case in the region of the aligned sections of the finger elements, and in that, preferably, the respectively aligned sections of the finger elements bear on one side against a semipermeable membrane and on the opposite side against a non-porous section of the electrode, in particular of the bipolar plate.
